(19) United States
(12) Patent Application Publication
(10) Pub. No.: US 2026/0275237 A1
(43) Pub. Date: Sep. 17, 2026

(54) MICRO-PLASTIC FREE, OPACIFIED LIQUID DETERGENTS WITH IMPROVED MILDNESS

(71) Applicant: Henkel AG & Co. KGaA, Duesseldorf (DE)

(72) Inventors: Daniel Thomas Piorkowski, Fairfield, CT (US); Damian Rydzewski, Stamford, CT (US)

(73) Assignee: Henkel AG & Co. KGaA, Duesseldorf (DE)

(21) Appl. No.: 19/436,386

(22) Filed: Dec. 30, 2025

Related U.S. Application Data
(60) Provisional application No. 63/773,286, filed on Mar. 17, 2025.

(51) Int. Cl. C11D 1/831; C11D 3/10; C11D 3/20; C11D 3/33; C11D 3/37

(52) U.S. Cl. CPC C11D 1/831; C11D 3/10; C11D 3/2079; C11D 3/2086; C11D 3/33; C11D 3/3765

(57) ABSTRACT

The present disclosure provides an opaque, mild liquid detergent composition comprising surfactants and fatty acids with improved mildness while maintaining cleaning performance. The opaque liquid detergent composition is substantially free a linear alkyl benzene sulfonates, microplastic opacifiers, and magnesium (Mg) and/or calcium (Ca) cations, and has a pH of below 7. The detergent composition has a Zein score of not more than about 2% dissolved zein when tested on a 10% dilution.

### BACKGROUND

Liquid laundry detergent compositions often utilize opacifiers to enhance the aesthetic and/or textural appearance of the liquid detergent. For example, many liquid detergents include microplastic opacifiers to provide a “milky” or “lotionized” appearance to the liquid detergent. Although suitable for their intended use, microplastic opacifiers do not degrade well. Opacity can also be achieved with the addition of calcium or magnesium ions. The calcium/magnesium cations, in combination with anionic linear alkylbenzene sulfonates (LAS) and fatty acids form crystals suspended in the liquid components of the detergent composition and gives the composition an opacified appearance. Additionally, LAS can be a harsh additive to detergent compositions, impacting the composition's mildness.

Achieving suitable opacification of liquid detergent compositions, while avoiding unwanted mineral deposits, has been a challenge.

Consumers generally prefer mild liquid detergent formulations that are aesthetically pleasing, and several products that claim to be mild are currently on the market. There is a still a need to develop improved, mild, opacified, liquid detergent formulations that have good cleaning performance.

### BRIEF SUMMARY

The present disclosure relates to an opaque liquid laundry detergent composition comprising water, about 10 to about 30 wt % of a non-ionic surfactant, less than about 10 wt % of an anionic surfactant, about 2 to about 4 wt % of a fatty acid, and citric acid, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the detergent composition has a pH below 6.

In some aspects, the anionic surfactant is an alkyl ether sulfate and the non-ionic surfactant is an alcohol ethoxylate.

In some aspects, the alkyl ether sulfate is lauryl ether sulfate.

In some aspects, non-ionic surfactant is an alcohol ethoxylate. In some aspects, the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15. In some aspects, n is 7.

In some aspects, the detergent composition has a Zein score of not more than about 2%. In some aspects, the detergent composition has a Zein score of not more than about 1%.

In some aspects, the detergent composition further comprises at least one additive selected from an acid, a base, an amino acid, a chelant, a polymer, a chlorine scavenger, a preservative, a carbonate, an optical brightener, a fragrance, one or more enzymes, a corrosion inhibitor, and combinations thereof.

In some aspects, the detergent composition further comprises a preservative.

In some aspects, the detergent composition further comprises a chelant. In some aspects, the chelant is methylglycinediacetic acid (MGDA).

In some aspects, the detergent composition comprises polymer. In some aspects, the polymer is an acrylic acid polymer.

In some aspects, the detergent composition further comprises a carbonate. In some aspects, the carbonate is sodium carbonate.

In some aspects, the detergent composition comprises about 2 to about 3 wt % of a fatty acid.

In some aspects, the detergent composition comprises about 0.1 to about 2 wt % of citric acid.

In some aspects, the detergent composition has a separation index of less than 0.01 after 15 weeks at 25° C.

In some aspects, the detergent composition comprises about 10 to about 15 wt % of non-ionic surfactant, about 7 to about 9 wt % of an anionic surfactant, about 2 to about 3 wt % of a fatty acid, a chelant, a polymer, and citric acid.

### DETAILED DESCRIPTION

Provided herein is an opaque liquid laundry detergent composition comprising water, about 10 to about 30 wt % of a non-ionic surfactant, less than about 10 wt % of an anionic surfactant, about 2 to about 4 wt % of a fatty acid, and citric acid, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little to none of the specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the detergent composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “opaque” or “opacity” as used in the present application refers to a slightly opaque or translucent appearance in which some (but not all) light can be transmitted through the liquid such that objects behind the liquid cannot be seen clearly, an extremely opaque appearance in which no light can be transmitted through the liquid such that no objects behind the liquid can be seen clearly, and any level of opaqueness in-between.

The term “Zein score” or “Zein number” as used in the present application refers to a score or number measured using a Zein test (see, e.g., US 2018/0016523), as described in the examples. A Zein test determines the extent of denaturation of Zein corn protein after exposure to a surfactant for a given period of time. Generally, the higher the Zein score, the greater the skin irritation potential.

In some aspects, the detergent compositions described herein have a Zein score of less than about 2% dissolved zein when tested at a 3% dilution. In other aspects the detergent compositions described herein have a Zein score of less than 1% dissolved zein when tested at a 3% dilution. The protocol can also be run on a detergent composition tested at a 10% dilution. In other aspects, the detergent compositions described herein at a 3% dilution (or a 10% dilution) have a Zein score of from about 0.01% to about 2%, from about 0.01% to about 1.75%, about 0.01% to about 1.5%, or about 0.01% to about 1.25%, or about 0.01% to about 1% dissolved zein.

### Detergent Composition

In some aspects, the present disclosure is directed to an opaque liquid laundry detergent composition comprising water, about 10 to about 20 wt % of a non-ionic surfactant, less than about 10 wt % of an anionic surfactant, about 2 to about 4 wt % of a fatty acid, and citric acid, wherein the opaque liquid detergent composition does not comprise a linear alkyl benzene sulfonate, wherein the opaque liquid detergent is substantially free of magnesium (Mg) and calcium (Ca) cations, and wherein the opaque liquid detergent composition has a pH of below 7.

In some aspects, the liquid detergent composition is considered suitably opacified when the liquid detergent composition has a turbidity value of greater than about 250 turbidity units (NTUs) measured utilizing a turbidity meter (such as a 2100N Laboratory Turbidimeter available from Hach Company (Loveland, Colo.)) at 24° C. At this turbidity, the liquid detergent composition is considered to be opacified, i.e., having a cloudy, milky, or lotionized appearance. In another aspect, the liquid detergent composition of the present disclosure has a turbidity value of at least 2000 NTUs measured using the turbidity meter at 24° C. In another aspect, the liquid detergent composition has a turbidity value of from about 2000 to about 3000 NTUs measured using the turbidity meter at 24° C. In some aspects, the opacified liquid detergent composition is not transparent, where light can be transmitted through the liquid such that objects behind the liquid can be clearly seen.

In some aspects, the opaque liquid detergent composition comprises water in any amount that is sufficient to bring the total weight of the composition to 100 wt % (q.s.).

It was observed that Zein scores were improved at lower pH ranges. In some aspects, the opaque liquid detergent composition has a pH of below 7. In some aspects, the detergent composition has a pH of below 6.8, below 6.5, below 6.2, below 6, below 5.8, below 5.5, below 5.2, below 5, below 4.8, below 4.5, below 4.2, below 4, below 3.8, or below 3.5. In some aspects, the detergent composition has a pH of below 7. In some aspects, the detergent composition has a pH of below 6. In some aspects, the detergent composition has a pH of below 5.5.

In some aspects, the detergent composition can have a pH of about 2 to about 7 (e.g., about 2.5 to about 6.5, about 3 to about 6, about 3.5 to about 6, about 4 to about 6, about 4.5 to about 6, about 5 to about 6, about 5.5 to about 6, about 2.5 to about 5.8, about 2.5 to about 5.5, about 2.5 to about 5.3, about 2.5 to about 5.2, about 2.5 to about 5, about 3 to about 5.8, about 3 to about 5.5, about 3 to about 5.3, about 3 to about 5, about 3 to about 4.8, about 3 to about 4.5, about 3 to about 4.3, or about 3 to about 4). In some aspects, the detergent composition has a pH of about 6, about 5.5, about 5, about 4.5, about 4, about 3.5, about 3, or about 2.5. In some aspects, the detergent composition has a pH of about 3 to about 6. In some aspects, the detergent composition has a pH of about 6. In some aspects, the detergent composition has a pH of about 5.5. In some aspects, the detergent composition has a pH of about 5. In some aspects, the detergent composition has a pH of about 4.5.

Mildness is a significant consumer need and driver for laundry detergent purchase. There are several methods to measure the skin irritancy potential of a surfactant composition, such as the testing methods as described in US 2018/0016523, the entire disclosure of which is incorporated herein by reference. These tests include Zein, Corneosufametry, and Cytokine testing. The aggregate of these scores can be used to determine the mildness of a detergent for consumers.

It was discovered that a mild composition (i.e., a composition with a low Zein score) could be provided with a detergent composition comprising mild surfactants and a low pH. In some aspects, the detergent composition has a Zein score that is not more than 2% dissolved zein when tested on a 10% dilution of the detergent composition when measured in accordance with the method set forth herein and in US 2018/0016523, the disclosure of which is incorporated herein by reference in its entirety. In some aspects, the detergent composition has a Zein score of not more than 2% dissolved zein when tested on a 10% dilution. In some aspects, the detergent composition has a Zein score of not more than 1% dissolved zein when tested on a 10% dilution. In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 10% dilution.

In some aspects, mildness of the detergent composition is controlled by the use of surfactants, fatty acid, and pH in varying amounts to improve mildness while maintaining stain removal performance and opacity.

It was surprisingly found that the inclusion of a fatty acid in specific amounts was able to maintain an opaque appearance of the liquid laundry detergent, even in the absence of microplastic opacifiers, LAS, and calcium and/or magnesium cations, which were previously believed to be necessary for opacification. In some aspects, the detergent composition comprises a fatty acid that helps maintain the liquid detergent's opacity. In some aspects the fatty acid comprises palm kernel fatty acid. In some aspects the fatty acid comprises coconut fatty acid. In some aspects, the detergent composition is substantially free of microplastic opacifiers. In some aspects, the detergent composition is substantially free of linear alkylbenzene sulfonate (LAS). In some aspects, the detergent composition is substantially free of calcium (Ca) and/or magnesium (Mg) cations. In some aspects, the detergent composition is substantially free of microplastic opacifiers, LAS, and calcium (Ca) and/or magnesium (Mg) cations.

In some aspects, the opaque liquid detergent composition comprises from about 1 wt % to about 10 wt % of a fatty acid relative to the total weight of the detergent composition. For example, the fatty acid can be from about 1 wt % to about 8 wt %, about 1 wt % to about 7 wt %, from about 1 wt % to about 6 wt %, about 1 wt % to about 5 wt %, from about 1 wt % to about 4 wt %, about 1 wt % to about 2 wt %, from about 2 wt % to about 8 wt %, about 2 wt % to about 6 wt %, from about 2 wt % to about 4 wt %, about 1 wt %, about 2 wt %, about 3 wt %, about 4 wt %, about 5 wt %, about 6 wt %, about 7 wt %, about 8 wt %, about 9 wt %, or about 10 wt % of the total weight of the detergent composition. In some aspects the detergent composition comprises at least 2 wt % of a fatty acid. In some aspects, the detergent composition comprises about 2 wt % to about 4 wt % of a fatty acid (e.g., coconut fatty acid) relative to the total weight of the detergent composition. In some aspects, the detergent composition comprises about 2 wt % to about 3 wt % of a fatty acid (e.g., coconut fatty acid).

As commercial consumer products, liquid detergent formulations are usually stored and used over a period of time and their appearance and cleaning properties should remain stable for at least their shelf life. Instabilities of am opaque liquid detergent composition can include visible changes such as phase separation, particulate formation, crystallization, discoloration, as well as chemical changes that result in diminished cleaning performance.

In some aspects, stability of the opaque liquid detergent can be measured optically using an analytical centrifuge. Using an analytical centrifuge, the extinction (space- and time-resolved) of the transmitted light across the entire length of a sample can be measured. An analytical centrifuge also allows for the stability and the shelf-life of the liquid compositions to be calculated. In some embodiments, the analytical centrifuge is a LUMISIZER (LUM GmbH, Germany). The analytical centrifuge measures the gravitational separation of the opacified liquid composition. The analytical centrifuge calculates a separation index value for the liquid composition between 0 and 1.0 with 1.0 being 100% separated and less than 0.1 being considered stable at room temperature.

In some aspects, the opaque liquid detergent composition has a separation index value of less than 0.1 at 25° C. at 1 g-force for a period of about 1 to about 15 weeks. In some aspects, the detergent composition has a separation index value of less than 0.1, less than 0.05, less than 0.04, less than 0.03, less than 0.02, less than 0.01, less than 0.009, less than 0.008, less than 0.007, less than 0.006, less than 0.005, or less than 0.004, at 25° C. at 1 g-force for a period of about 1 to about 15 weeks. In some aspects, the detergent composition has a separation index of less than 0.01 after 15 weeks at 25° C. In some aspects, the detergent composition has a separation index of less than 0.006 after 15 weeks at 25° C. In some aspects, the detergent composition has a separation index of less than 0.005 after 15 weeks at 25° C.

In some aspects, the opaque liquid detergent composition is stable (e.g., does not exhibit a separation index of greater than 0.01) at room temperature, i.e, 25° C., for a period of about 1 week to about 15 weeks. For example, the detergent composition is stable at room temperature for a period of about 1 week, about 2 weeks, about 3 weeks, about 4 weeks, about 5 weeks, about 6 weeks, about 7 weeks, about 8 weeks, about 9 weeks, about 10 weeks, about 11 weeks, about 12 weeks, about 13 weeks, about 14 weeks, or about 15 weeks.

In some aspects, the opaque liquid detergent composition comprises an anionic surfactant, a cationic surfactant, a zwitterionic surfactant, a nonionic surfactant, or a combination thereof. In some aspects, the detergent composition comprises an anionic surfactant and a nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.).

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (AES)).

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate. In some aspects, the AES is sodium laureth sulfate having three ethoxylate groups.

In some aspects, the opaque liquid detergent composition comprises less than about 10 wt % of an anionic surfactant (e.g., an alkyl ether sulfate (AES)) relative to the total weight of the detergent composition. In some aspects, the detergent composition comprises less than about 10 wt %, less than about 9.5 wt %, less than about 9 wt %, less than about 8.5 wt %, less than about 8 wt % of an anionic surfactant. In some aspects, the anionic surfactant is present in an amount of less than 10 wt %.

In some aspects, the opaque liquid detergent composition comprises from about 0.1 wt % to about 9 wt % of an anionic surfactant relative to the total weight of the detergent composition. For example, the total anionic surfactant content can be from about 0.1 wt % to about 9 wt %, about 0.1 wt % to about 8.5 wt %, about 0.1 wt % to about 8 wt %, from about 0.1 wt % to about 7.8 wt %, from about 0.1 wt % to about 7.6 wt %, from about 0.1 wt % to about 7.4 wt %, from about 0.1 wt % to about 7.2 wt %, from about 0.1 wt % to about 7 wt %, from about 0.1 wt % to about 6.8 wt %, from about 0.1 wt % to about 6.6 wt %, from about 0.1 wt % to about 6.4 wt %, from about 0.1 wt % to about 6.2 wt %, from about 0.1 wt % to about 6 wt %, from about 0.1 wt % to about 5.8 wt %, from about 0.1 wt % to about 5.6 wt %, from about 0.1 wt % to about 5.4 wt %, from about 0.1 wt % to about 5.2 wt %, from about 0.1 wt % to about 5 wt %, from about 0.1 wt % to about 4.8 wt %, from about 0.1 wt % to about 4.6 wt %, from about 0.1 wt % to about 4.4 wt %, from about 0.1 wt % to about 4.2 wt %, from about 0.1 wt % to about 4 wt %, from about 0.1 wt % to about 3.8 wt %, from about 0.1 wt % to about 3.6 wt %, from about 0.1 wt % to about 3.4 wt %, from about 0.1 wt % to about 3.2 wt %, from about 0.1 wt % to about 3 wt %, from about 0.1 wt % to about 2.8 wt %, from about 0.1 wt % to about 2.6 wt %, from about 0.1 wt % to about 2.4 wt %, from about 0.1 wt % to about 2.2 wt %, from about 0.1 wt % to about 1 wt %, from about 0.1 wt % to about 0.8 wt %, from about 0.1 wt % to about 0.6 wt %, from about 0.1 wt % to about 0.4 wt %, from about 0.1 wt % to about 0.2 wt %, about 0.1 wt %, about 0.5 wt %, about 1 wt %, about 2 wt %, about 3 wt %, about 4 wt %, about 5 wt %, about 6 wt %, about 7 wt %, or about 8 wt % of the total weight of the detergent composition. In some aspects, the detergent composition comprises about 7 to about 9 wt % of an anionic surfactant (e.g., an alkyl ether sulfate (AES)).

In some aspects, the opaque liquid detergent composition does not comprise or is substantially free of a linear alkylbenzene sulfonate (LAS). LAS has the structure of Formula (I).

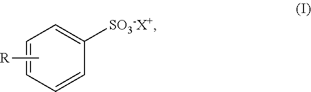

in which R is a linear C₁₀-C₁₈ (e.g., C₁₀, C₁₁, C₁₂, C₁₃, C₁₄, C₁₅, C₁₆, C₁₇, and C₁₈) alkyl, and X is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the anionic surfactant comprises an alkyl sulfate (e.g., a lauryl sulfate), an alkyl ether sulfate, a methyl ester sulfonate, or a combination thereof. In some aspects, the anionic surfactant comprises an alkyl ether sulfate (AES).

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate.

In general, the alcohol ethoxylate (AE) will have a chemical structure of formula (I).

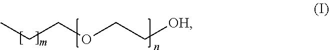

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol. In some aspects, the alcohol ethoxylate comprises ethoxylated lauryl alcohol with 7 moles of ethoxylate.

In some aspects, the opaque liquid detergent composition comprises from about 10 wt % to about 30 wt % of a nonionic surfactant (e.g., an alcohol ethoxylate (AE)), relative to the total weight of the detergent composition. For example, the total non-ionic surfactant content can be from about 10 wt % to about 29 wt %, from about 10 wt % to about 28 wt %, about 10 wt % to about 27 wt %, about 10 wt % to about 26 wt %, from about 10 wt % to about 25 wt %, from about 10 wt % to about 24 wt %, from about 10 wt % to about 23 wt %, from about 10 wt % to about 22 wt %, from about 10 wt % to about 21 wt %, from about 10 wt % to about 20 wt %, from about 10 wt % to about 19 wt %, about 10 wt % to about 18 wt %, about 10 wt % to about 17 wt %, about 10 wt % to about 16 wt %, about 10 wt % to about 15 wt %, about 10 wt % to about 14 wt %, about 10 wt % to about 13 wt %, about 10 wt % to about 12 wt %, about 10 wt % to about 11 wt %, about 11 wt % to about 20 wt % about 11 wt % to about 19 wt %, about 11 wt % to about 18 wt %, about 11 wt % to about 17 wt %, about 11 wt % to about 16 wt %, about 11 wt % to about 15 wt %, about 11 wt % to about 14 wt %, about 11 wt % to about 13 wt %, about 11 wt % to about 12 wt %, about 12 wt % to about 20 wt % about 12 wt % to about 19 wt %, about 12 wt % to about 18 wt %, about 12 wt % to about 17 wt %, about 12 wt % to about 16 wt %, about 12 wt % to about 15 wt %, about 12 wt % to about 14 wt %, about 12 wt % to about 13 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt % or about 10 wt %, of the total weight of the detergent composition. In some aspects, the detergent composition comprises about 10 to about 20 wt % of a non-ionic surfactant. In some aspects, the detergent composition comprises about 10 to about 15 wt % of a non-ionic surfactant (e.g., a non-ionic alcohol ethoxylate (AE)).

In some aspects, the opaque liquid detergent composition comprises an alcohol ethoxylate (AE) and an alkyl ether sulfate (AES). In some aspects, the detergent composition comprises an alcohol ethoxylate (AE), an alkyl ether sulfate (AES), and does not comprise (e.g., is substantially free of) a linear alkylbenzene sulfonate.

In some aspects, the opaque liquid detergent composition further comprises at least one additive. For example, the at least one additive can be selected from an acid, a base, an amino acid, a chelant, a polymer (e.g., an anti-redeposition agent polymer and/or a performance polymer), a chlorine scavenger, a preservative, a carbonate, an optical brightener, a fragrance, one or more enzymes, a corrosion inhibitor, and any combination thereof.

In some aspects, the opaque liquid detergent composition comprises from about 1 wt % to about 20 wt % of a total amount of additives relative to the total weight of the detergent composition. For example, the total amount of additives can be from about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 20 wt %, about 1.5 wt % to about 18 wt %, about 1.5 wt % to about 15 wt %, about 1.5 wt % to about 12 wt %, about 1.5 wt % to about 10 wt %, about 1.5 wt % to about 8 wt %, about 1.5 wt % to about 5 wt %, about 1.5 wt % to about 3 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % of the total weight of the detergent composition.

To help maintain the pH, in some aspects, the opaque liquid detergent composition can further comprise an acid, which is any suitable compound with a pKa of less than about 10. In some aspects, the acid is an inorganic acid or an organic acid. In some aspects, the acid is a weak acid such that the acid has a pKa of 2 or greater (e.g., pKa is about 2 to about 10). Examples of a weak acid include, e.g., an organic acid or carbonic acidIn some aspects, the acid in the opaque liquid detergent composition is an organic acid, which in some instances can additionally act as a chelating agent. The organic acid can contain one or more (e.g., 1, 2, or 3) carboxylic acid groups, which can be used singly or in combination. In some aspects, the acid in the detergent composition is citric acid. In some aspects, the acid can be an acid solution (e.g., an acid in water).

In some aspects, the opaque liquid detergent composition comprises from about 0.1 wt % to about 10 wt % of acid (e.g., an organic acid, such as citric acid) relative to the total weight of the detergent composition. For example, the acid can be present in an amount of about 0.1 wt % to about 5 wt %, about 0.1 wt % to about 3 wt %, about 0.1 wt % to about 2 wt %, about 0.1 wt % to about 1 wt %, about 0.1 wt % to about 0.8 wt %, about 0.1 wt % to about 0.6 wt %, about 0.1 wt % to about 0.4 wt %, about 0.1 wt % to about 0.3 wt %, about 0.2 wt % to about 10 wt %, about 0.2 wt % to about 5 wt %, about 0.2 wt % to about 3 wt %, about 0.2 wt % to about 2 wt %, about 0.2 wt % to about 1 wt %, about 0.2 wt % to about 0.8 wt %, about 0.2 wt % to about 0.6 wt %, about 0.2 wt % to about 0.4 wt %, about 0.2 wt % to about 0.3 wt %, about 0.5 wt % to about 10 wt %, about 0.5 wt % to about 5 wt %, about 0.5 wt % to about 3 wt %, about 0.5 wt % to about 2 wt %, about 0.5 wt % to about 1 wt %, about 0.5 wt % to about 0.8 wt %, about 0.5 wt % to about 0.6 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 0.1 wt %, about 0.15 wt %, about 0.2 wt %, about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the detergent composition. In some aspects, the detergent composition comprises from about 0.1 wt % to about 1 wt %, or about 0.2 wt % to about 0.5 wt % of an organic acid (e.g., citric acid). In some aspects, the detergent composition comprises about 0.1 wt % to about 2 wt % of citric acid. In some aspects, the detergent composition comprises about 0.2 wt % to about 2 wt % of citric acid.

In some aspects, the opaque liquid detergent composition comprises a base to adjust the pH. The base can be any suitable compound with a pKb of about 0.1 to about 13. In some aspects, the base can be monoethanolamine, diethanolamine, triethanolamine, methyl diethanolamine, a hydroxide, a tetraborate, a phosphate, a carbonate, a bicarbonate, or any combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the base can be a base solution (e.g., a base in water). In some aspects, the detergent composition comprises a carbonate. In some aspects, the base in the detergent composition is sodium hydroxide. In some aspects, the base is a base solution (e.g., a 50% or 70% sodium hydroxide solution).

In some aspects, the opaque liquid detergent composition comprises from about 0.1 wt % to about 15 wt % of base relative to the total weight of the detergent composition. For example, the base can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the detergent composition. In some aspects, the detergent composition comprises from about 0.1 wt % to about 5 wt %, from about 0.1 wt % to about 3 wt %, or from about 0.1 wt % to about 2 wt % of base. In some aspects, the detergent composition comprises not more than 3 wt % sodium hydroxide (e.g., a 50% NaOH solution). In some aspects, the detergent composition comprises from about 1 wt % to about 2 wt % of a carbonate. In some aspects, the detergent composition does not comprise a base.

In some aspects, the opaque liquid detergent composition comprises an acid and a base to form a buffer. The buffer can be any suitable composition that is water soluble and controls (i.e., maintains) the pH of the detergent composition within a pH of about 5 to about 7.7 (e.g., maintains a pH of about 5, about 5.5, about 6, about 6.5, about 7, about 7.5, or about 7.7). In some embodiments, the pH can be controlled to be within a range of about 5 to about 6 or a pH of about 5. In general, the buffer can comprise a weak acid and its conjugate base, a strong acid and a weak base, or a strong base and a weak acid. Examples of suitable acids and bases are described herein. In general, a strong acid will have a pKa of less than 2 and a weak acid will have a pKa of 2 or greater. In general, a strong base will have a pKb of less than 2 and a weak base will have a pKb of 2 or greater. For example, the buffer can comprise sodium hydroxide in combination with a weak acid, such as citric acid.

In some aspects, the opaque liquid detergent composition comprises a chelating agent (i.e., a chelant) that serves to improve the cleaning action of the detergent by scavenging metal ions naturally found in water. Suitable examples of a chelating agent includes, e.g., methylglycindiacetic acid (MGDA), citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid (pentetic acid), hydroxyethylethylenediaminetriacetic acid, ethylenediamine-N,N′-disuccinic acid (EDDS), glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate (IDS)), or any combination thereof. In some aspects, the detergent composition comprises methylglycindiacetic acid (MGDA).

In some aspects, the opaque liquid detergent composition comprises from about 0.001 wt % to about 2 wt % of a chelating agent relative to the total weight of the detergent composition. For example, the chelating agent can be present in an amount from about 0.001 wt % to about 2 wt %, about 0.001 wt % to about 1.9 wt %, about 0.001 wt % to about 1.8 wt %, about 0.001 wt % to about 1.7 wt %, about 0.001 wt % to about 1.6 wt %, about 0.001 wt % to about 1.5 wt %, about 0.001 wt % to about 1.4 wt %, about 0.001 wt % to about 1.3 wt %, about 0.001 wt % to about 1.2 wt %, about 0.001 wt % to about 1.1 wt %, from about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.6 wt %, about 0.001 wt % to about 0.5 wt %, about 0.001 wt % to about 0.4 wt %, about 0.001 wt % to about 0.3 wt %, about 0.001 wt % to about 0.2 wt %, about 0.001 wt % to about 0.1 wt %, about 0.001 wt % to about 0.09 wt %, about 0.001 wt % to about 0.08 wt %, about 0.001 wt % to about 0.07 wt %, about 0.001 wt % to about 0.06 wt %, about 0.001 wt % to about 0.05 wt %, about 0.001 wt % to about 0.04 wt %, about 0.001 wt % to about 0.03 wt %, about 0.001 wt % to about 0.02 wt %, about 0.001 wt % to about 0.01 wt %, about 0.001 wt % to about 0.009 wt %, about 0.001 wt % to about 0.008 wt %, about 0.001 wt % to about 0.007 wt %, about 0.001 wt % to about 0.006 wt %, about 0.001 wt % to about 0.005 wt %, about 0.001 wt % to about 0.004 wt %, about 0.001 wt % to about 0.003 wt %, or about 0.001 wt % to about 0.002 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises from about 0.1 wt % to about 1 wt % of a chelating agent (e.g., methylglycindiacetic acid (MGDA)). In some aspects, the detergent composition comprises about 1 wt % of a chelating agent (e.g., methylglycindiacetic acid (MGDA)).

In some aspects, the opaque liquid detergent compositions comprises a preservative or biocide, which is any suitable compound with antimicrobial (e.g., antibacterial, antiviral, antifungal) activity. Examples of a preservative that can be contained in the detergent composition include, sodium benzoate, sorbate, dichloroisocyanuric acid, hydrogen peroxide, a quaternary ammonium compound, glutaraldehyde, tetrakis(hydroxymethyl)phosphonium sulfate (THPS), 2,2-dibromo-3-nitrilopropionamide (DBNPA), 2,2-dibromo-3-nitrilpropionamide, 2-(hydroxymethylamino)-ethanol, 2-bromo-2-nitropropane-1,3-diol, p-bromo-p-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorthalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, and any combination thereof. In some aspects, the opaque liquid detergent composition comprises sodium benzoate. In some aspects, the opaque liquid detergent composition comprises sorbate.

In some aspects, the opaque liquid detergent composition comprises from about 0.001 wt % to about 1 wt % of a preservative relative to the total weight of the detergent composition. For example, the preservative can be present in an amount from about 0.001 wt % to about 1 wt %, about 0.001 wt % to about 0.9 wt %, about 0.001 wt % to about 0.8 wt %, about 0.001 wt % to about 0.7 wt %, about 0.001 wt % to about 0.6 wt %, about 0.001 wt % to about 0.5 wt %, about 0.001 wt % to about 0.4 wt %, about 0.001 wt % to about 0.3 wt %, about 0.001 wt % to about 0.2 wt %, about 0.001 wt % to about 0.1 wt %, about 0.001 wt % to about 0.09 wt %, about 0.001 wt % to about 0.08 wt %, about 0.001 wt % to about 0.07 wt %, about 0.001 wt % to about 0.06 wt %, about 0.001 wt % to about 0.05 wt %, about 0.001 wt % to about 0.04 wt %, about 0.001 wt % to about 0.03 wt %, about 0.001 wt % to about 0.02 wt %, about 0.001 wt % to about 0.01 wt %, about 0.001 wt % to about 0.009 wt %, about 0.001 wt % to about 0.008 wt %, about 0.001 wt % to about 0.007 wt %, about 0.001 wt % to about 0.006 wt %, about 0.001 wt % to about 0.005 wt %, about 0.001 wt % to about 0.004 wt %, about 0.001 wt % to about 0.003 wt %, or about 0.001 wt % to about 0.002 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, of the total weight of the detergent composition. In some aspects, the detergent composition comprises from about 0.1 wt % to about 0.2 wt % of a preservative. In some aspects, the detergent composition does not comprise a preservative.

In some aspects, the opaque liquid detergent composition comprises an anti-redeposition agent that keeps dissolved soil stains stable in the wash water and prevent the stains from redepositing on a textile. In some aspects, the anti-redeposition agent is a biodegradable polymer. The anti-redeposition agent (e.g., anti-redeposition polymer) can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethyleneimine, or a combination thereof. In some aspects, the anti-redeposition agent comprises sodium polyacrylate.

In some aspects, the opaque liquid detergent composition comprises from about 0.001 wt % to about 5 wt % of an anti-redeposition agent relative to the total weight of the detergent composition. For example, the anti-redeposition agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition. In some aspects, the detergent composition further comprises a polymer (e.g., an anti-redeposition polymer). In some aspects, the detergent composition comprises from about 0.1 wt % to about 5 wt % of an anti-redeposition polymer (e.g., homopolymer of acrylic acid). In some aspects, the detergent composition comprises from about 0.1 wt % to about 1 wt % of an anti-redeposition polymer (e.g., homopolymer of acrylic acid).

In some aspects, the opaque liquid detergent composition comprises a performance polymer that improves at least one aspect of a washed textile. In some aspects, the performance polymer improves the cleaning action of the detergent composition, removes or reduces stains, maintains whiteness, protects color, protects the integrity of a textile, provides odor control, or any combination thereof.

In some aspects, the opaque liquid detergent composition comprises an enzyme to aid in removing stains, including protein stains, oil stains, tannin stains, starch stains, and dyes. For example, a protease is capable of breaking down protein-based stains, such as sweat, blood, mud, and dairy products.

In some aspects, the opaque liquid detergent composition comprises a chlorine scavenger. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor.

In some aspects, the opaque liquid detergent composition comprises an optical brightener (e.g., a fluorescent whitening agent), which is any suitable hydrophilic compound that absorbs ultra violet light and emits visible (e.g., blue-violet) light to make textiles appear brighter.

In some aspects, the opaque liquid detergent composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting.

In some aspects, the opaque liquid detergent composition comprises a fragrance. The fragrance can be any suitable fragrance oil or encapsulated fragrance that is generally regarded as safe (GRAS) at the levels used in the liquid composition. In some aspects, the detergent composition comprises a fragrance oil. In some aspects, the detergent composition comprises an encapsulated fragrance.

In some aspects, the opaque liquid detergent composition comprises an acid, a base, at least one anti-redposition polymer, a preservative, and a chelating agent. In some aspects, the detergent composition comprises sodium hydroxide, citric acid, a preservative, an anti-redeposition polymer and sodium carbonate as additives. In some aspects, the detergent composition comprises an acid, a base, a preservative, a fragrance, and a chelating agent. In some aspects, the detergent composition comprises a carbonate, citric acid, a preservative, and MGDA, as additives.

In some aspects, the opaque liquid detergent composition comprises water, a non-ionic surfactant, an anionic surfactant, a fatty acid, and citric acid, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the opaque liquid detergent composition comprises water, a non-ionic surfactant, an anionic surfactant, a fatty acid, citric acid, a chelant, and an anti redeposition polymer, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the opaque liquid detergent composition comprises water, about 10 wt % to about 30 wt % of a non-ionic surfactant, less than 10 wt % of an anionic surfactant, about 1 wt % to about 5 wt % of a fatty acid, and about 0.1 to about 2 wt % of citric acid, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the opaque liquid detergent composition comprises water, about 10 wt % to about 30 wt % of a non-ionic surfactant, less than 10 wt % of an anionic surfactant, about 1 wt % to about 5 wt % of a fatty acid, about 0.1 to about 2 wt % of citric acid, about 0.5 wt % to about 1 wt % of a chelant, and about 0.1 wt % to about 1 wt % of an anti-redeposition polymer, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the opaque liquid detergent composition comprises water, about 10 to 15 wt % of an alcohol ethoxylate (AE), about 5 to about 9 wt % of an alkyl ether sulfate (AES), and about 0.5 to 0.9 wt % of MGDA, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 7.

In some aspects, the opaque liquid detergent composition comprises water, about 10 to 15 wt % of an alcohol ethoxylate (AE), about 5 to about 9 wt % of an alkyl ether sulfate (AES), and about 0.5 to 0.9 wt % of MGDA, wherein the opaque liquid detergent composition does not comprise a linear alkyl benzene sulfonate, wherein the opaque liquid detergent composition does not comprise a microplastic opacifier, wherein the opaque liquid detergent is substantially free of magnesium (Mg) and calcium (Ca) cations, and wherein the opaque liquid detergent composition has a pH of below 6.

In some aspects, the detergent composition is a liquid, including a liquid that is dispensed from a container upon use.

In some aspects, the present disclosure is directed to a method of using the detergent composition of any of the foregoing aspects. For example, the detergent composition can be used in a method of removing soil from a textile (e.g., cleaning a textile, such as a fabric). In particular, the present disclosure is directed to a method of removing soil from a textile comprising contacting the textile with a composition comprising the detergent composition described herein and water to form a washing load. Optional steps include mixing (e.g., agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and any combination thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 10-20° C., about 12-16° C., or about 15° C.).

In an aspect, the method is directed to providing an opacified mild detergent composition.

In an aspect, the method is directed to providing an allergen-free detergent composition.

In an aspect, the method is directed to providing detergent compositions comprising Safer Choice ingredients.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

A base detergent composition (Base Formulation 1) was prepared with the components listed in Table 1. Formulation 1 was post dosed with citric acid or sodium hydroxide to match a target pH ranging from 5 to 11.4. The resulting detergent compositions (Formulations 1A-H) were then evaluated for Zein. The resulting Zein scores are shown below in Table 2.

TABLE 1
Base Formulation 1

| Material | % |
|---|---|
| Water | QS to 100 |
| Alcohol Ethoxylate | 11.28 |
| SLES, 3 EO (70% active) | 8.06 |
| Fatty Acid | 0.23 |
| Carbonate, Polymer, MGDA, and Preservative | 2.8 |

SLES: sodium lauryl ether sulfate
EO: ethoxylate
MGDA: methylglycinediacetic acid

TABLE 2

| Formula | pH | Zein Avg. |
|---|---|---|
| 1A | 11.4 | 1.57 |
| 1B | 11 | 1.57 |
| 1C | 10 | 1.43 |
| 1D | 9 | 1.26 |
| 1E | 8 | 1.12 |
| 1F | 7 | 0.98 |
| 1G | 6 | 0.83 |
| 1H | 5 | 0.65 |

The resulting Zein scores show that the detergent composition demonstrated improved Zein scores as pH was lowered.

### Example 2

A second base detergent composition (Base Formulation 2) was prepared with the components listed in Table 3. Formulation 2 was post dosed with citric acid in varying amounts to match a target pH ranging from 6.4 to 4.5 resulting in Formulations 2A-J. Formulations 2A-J were also post dosed with varying amount of fatty acid to determine the effect on the liquid detergent compositions' opacity. Opacity was measured utilizing a turbidity meter (2100N Laboratory Turbidimeter from Hach Company (Loveland, Colo.)) at 24° C. Formulations were considered suitably opacified when the liquid detergent composition had a turbidity value of greater than about 250 turbidity units (NTUs). At this turbidity, the liquid detergent composition has a cloudy, milky, or lotionized appearance. The resulting formulations and their corresponding opacity is shown in Table 4.

TABLE 3
Base Formulation 2

| Material | % |
|---|---|
| Water | QS to 100 |
| Alcohol Ethoxylate | 11.6 |
| SLES, 3EO (70% active) | 8.29 |
| Polymer and MGDA | 1.45 |

SLES: sodium lauryl ether sulfate
EO: ethoxylate
MGDA: methylglycinediacetic acid

TABLE 4

| Sample | Fatty Acid % | pH | Opacity |
|---|---|---|---|
| 2A | 2.73 | 4.5 | Opaque, white |
| 2B | 2.73 | 4.5 | Opaque, white |
| 2C | 2.73 | 4.5 | Opaque white |
| 2D | 2.73 | 5 | Opaque, white |
| 2E | 2.73 | 5.5 | Opaque, white |
| 2F | 2.73 | 6 | Opaque, white |
| 2G | 1.73 | 6.2 | Clear |
| 2H | 2.10 | 5.2 | Semi-opaque |
| 2I | 2.10 | 6.4 | Clear |
| 2J | 1.73 | 5.4 | Semi-opaque |

The results of Table 4 show that compositions comprising less than 2.73% of fatty acid did not achieve opacity as a pH below 6 (Formulations 2H and 2J), while compositions with a pH above 6 were completely transparent (Formulations 2G and 2I).

### Example 3 (Stability)

Separation indices of Formulations 2A-2F, as described in Example 2 above, were measured to determine a 15-week stability of the compositions. Separation index was measured by utilizing a LUMi Sizer 12-channel dispersion analyzer, available from LUM GmbH (Berlin, Germany). In particular, the separation index is used to determine the amount of separation that would occur after 2550 hours (about 106 days or 15 weeks) at 25° C. at 1 g-force (standard room temperature stability). In this test, about 0.4 mL of each of Formulations 2A-2F was disposed in 2 mm polyamide synthetic cells and spun at 855 g-force for about 3 hours at a Light Factor of 1 at 25° C. The separation index of each of Formulations 2A-2F was determined utilizing SEPview® 6 software available from LUM GmbH by reading the sample cell between 115.2 mm and 129.7 mm. The separation indices range from 0 to 1, with 0 signifying 0% separation (complete stability) and 1 signifying 100% separation. A separation index of less than 0.1 is considered stable at room temperature. The resulting separation indices and stabilities are shown below in Table 5.

TABLE 5

| Sample | Separation Index | Observed stability |
|---|---|---|
| 2A | 0.005 | Stable |
| 2B | 0.005 | Stable |
| 2C | 0.004 | Stable |
| 2D | 0.004 | Stable |
| 2E | 0.006 | Stable |
| 2F | 0.010 | Stable |

As shown in Table 5, each of Formulations 2A-F were stable after 15 weeks at 25° C. at 1 g-force.

### Example 4 (Yield Point)

The yield point was measured for Formulations 2A-F using a rheometer. The method was a sweep from 0 to 10 Pascals of shear stress at 20 degrees Celsius. The yield point was taken as the shear stress needed for the rheometer to begin measuring viscosity. The existence of a high enough yield point (0.5 or higher) could allow for the inclusion of encapsulated fragrances in the detergent without the need for additional rheology modifiers. The resulting yield points for Formulations 2A-F are shown below in Table 6.

TABLE 6

| Sample | Yield point (Pa) |
|---|---|
| 2A | .03 |
| 2B | 1.16 |
| 2C | 1.36 |
| 2D | 2.15 |
| 2E | 6.30 |
| 2F | 3.41 |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An opaque liquid detergent composition comprising:
i. water;
ii. about 10 to about 30 wt % of a non-ionic surfactant;
iii. less than about 10 wt % of an anionic surfactant;
iv. about 2 to about 4 wt % of a fatty acid; and
v. citric acid,
wherein the opaque liquid detergent composition does not comprise a linear alkyl benzene sulfonate,
wherein the opaque liquid detergent composition does not comprise a microplastic opacifier,
wherein the opaque liquid detergent is substantially free of magnesium (Mg) and calcium (Ca) cations, and
wherein the opaque liquid detergent composition has a pH of below 7.

2. The detergent composition of claim 1, wherein the composition has a pH below 6.

3. The detergent composition of claim 1, wherein the anionic surfactant is an alkyl ether sulfate and the non-ionic surfactant is an alcohol ethoxylate.

4. The detergent composition of claim 3, wherein the alkyl ether sulfate is lauryl ether sulfate.

5. The detergent composition of claim 3, wherein the non-ionic alcohol ethoxylate comprises the formula R¹-(EO)ₙ—OH, wherein R¹ is a C₁₂-C₁₈ alkyl group, EO is ethoxylate, and n is an integer of moles from 1 to 15.

6. The detergent composition of claim 5, wherein n is 7.

7. The detergent composition of claim 1, wherein the detergent composition has a Zein score of not more than about 2%.

8. The detergent composition of claim 7, wherein the detergent composition has a Zein score of not more than about 1%.

9. The detergent composition of claim 1, wherein the detergent composition further comprises at least one additive selected from an acid, a base, an amino acid, a chelant, a polymer, a chlorine scavenger, a preservative, a carbonate, an optical brightener, a fragrance, one or more enzymes, a corrosion inhibitor, and combinations thereof.

10. The detergent composition of claim 9, wherein the detergent composition further comprises a preservative.

11. The detergent composition of claim 9, wherein the detergent composition further comprises a chelant.

12. The detergent composition of claim 11, wherein the chelant is methylglycinediacetic acid (MGDA).

13. The detergent composition of claim 9, wherein the detergent composition comprises polymer.

14. The detergent composition of claim 13, wherein the polymer is an acrylic acid polymer.

15. The detergent composition of claim 9, wherein the detergent composition further comprises a carbonate.

16. The detergent composition of claim 15, wherein the carbonate is sodium carbonate.

17. The detergent composition of claim 1, wherein the detergent composition comprises about 2 to about 3 wt % of a fatty acid.

18. The detergent composition of claim 1, wherein the detergent composition comprises about 0.1 to about 2 wt % of citric acid.

19. The detergent composition of claim 1, wherein the detergent composition has a separation index of less than 0.01 after 15 weeks at 25° C.

20. The detergent composition of claim 1, comprising
about 10 to about 15 wt % of non-ionic surfactant;
about 7 to about 9 wt % of an anionic surfactant;
about 2 to about 3 wt % of a fatty acid;
a chelant;
a polymer; and
citric acid.
